(19) United States
(12) Patent Application Publication
(10) Pub. No.: US 2008/0182007 A1
(43) Pub. Date: Jul. 31, 2008

(54) FRIED LEGUME SNACK FOOD

(75) Inventors: Michelle Latrese Barnett, Plano, TX (US); Thomas George Crosby, Frisco, TX (US); David Guajardo-Flores, Guadalupe (MX)

Correspondence Address: CARSTENS & CAHOON, LLP, P O BOX 802334, DALLAS, TX, 75380, US

(73) Assignee: FRITO-LAY NORTH AMERICA, INC., Plano, TX (US)

(21) Appl. No.: 11/669,580

(22) Filed: Jan. 31, 2007

(51) Int. Cl. A23L 1/20; A23B 4/03

(52) U.S. Cl. 426/634; 426/460

(57) ABSTRACT

A fried legume snack food comprising a substantially intact cooked legume seed including its hull. Dried legumes are hydrated, par fried, and then finish dried. Rupturing of the hulls of the legumes during frying is avoided by either puncturing the hulls prior to cooking or by sequential cooking steps.

### BACKGROUND OF THE INVENTION

1. Technical Field

The present invention relates to a method for making a fried legume snack food and, more particularly, to a method for making a fried legume snack that retains the hulls of the legumes intact during processing.

2. Description of Related Art

Legumes, which are also known as dried beans and pulses, are the edible seeds that grown in pods on annual plants, bushes, or vines of the leguminosae family. The seeds can be eaten fresh, sprouted, dried and ground into flour, or prepared in other ways by cooking the legumes, legumes are often cooked in combination with grains because, when the amino acids contained in the grains and legumes are combined, they provide a complete protein source.

Legumes are a good source of protein and can be a healthy substitute for meat, which has more fat and cholesterol. Legumes are typically low in fat, contain no cholesterol, and are high in protein, folate, potassium, iron, and magnesium. They also have phytochemicals, a group of compounds that may help prevent chronic diseases, such as cardiovascular disease and cancer. In addition, they are an excellent source of fiber, and a diet high in fiber can reduce the risk of developing diabetes and help lower blood cholesterol levels, which in turn reduces the risk of heart disease.

There is a wide variety of legumes consumed by humans. Several of the more common types include black beans, black-eyed peas, chickpeas (garbanzo), fava or broad beans, lima beans, navy beans, peas, pinto beans, soy beans, and red kidney beans.

Consumers have recognized that legumes are an important part of a healthy diet. Consumer studies show that a legume snack, with a relatively low oil content, yet with a crunchy savory fried characteristic, would be a popular food item. Unfortunately, the dried legume seed has inadequate moisture to simply fry the seed, as this leads to burning of the legume. Legume seeds can be hydrated to a sufficiently high moisture level to fry. However, doing so can lead to the hull of the legume rupturing during frying due to the rapid generation of steam within the seed. As a consequence, the end product does not retain the original shape and continuity of the starting material. The hulls rupture and the end product looks more like exploded legumes. Further, frying a legume product that has been hydrated can result in the end product having a high oil content, which is not desirable for many consumers.

Consequently, the need exists for a method for making a fried legume product that is relatively low in oil content. Further, this method should insure that substantially all of the hulls on the legume remain intact and do not rupture during the cooking process.

### SUMMARY OF THE INVENTION

The present invention is a method for producing a fried legume product with a relatively low oil content and having hulls that remain substantially intact or without excessive rupturing. In a preferred embodiment, dried peas are hydrated to a moisture level of between 45% and 60%. Excess surface moisture from these peas is removed and the peas are then fried to a set oil level. The peas are then finish dried in a non-oil cooking environment, such as an impingement oven, resulting in the fried pea product having a final oil content of approximately 11% to 14%.

In order to avoid excessive rupturing of the hulls of the peas during frying, one embodiment of the invention involves puncturing the pea hulls prior to frying in order to allow steam release through the hulls without rupture. In an alternative embodiment, the frying of the peas takes place with successive batch frying steps with short cooling or resting periods between each step, thereby reducing the thermal stress on the hulls during frying.

In an alternative embodiment, surface starch, such as wheat starch or rice flour, is adhered to the exterior of the peas after the finish cooking step. This combination of a starch with the legume provides a unique mouth feel and a healthy combination of amino acids.

The end product of Applicants' invention is a nutritious and tasty snack product with a relatively low oil content. The legume snacks produced by Applicants' method substantially retain their shape and the integrity of the hulls during cooking and processing, thus resulting in a visually recognizable and appealing product.

These as well as additional features and advantages of the present invention will become apparent in the following written description.

### BRIEF DESCRIPTION OF THE DRAWINGS

The novel features believed characteristic of the invention are set forth in the appended claims. The invention itself, however, as well as a preferred mode of use, further objectives and advantages thereof; will be best understood by reference to the following detailed description of illustrative embodiments when read in conjunction with the accompanying drawings, wherein:

FIG. 1 is a flowchart indicating the processing steps for the present invention.

### DETAILED DESCRIPTION OF THE PREFERRED EMBODIMENTS

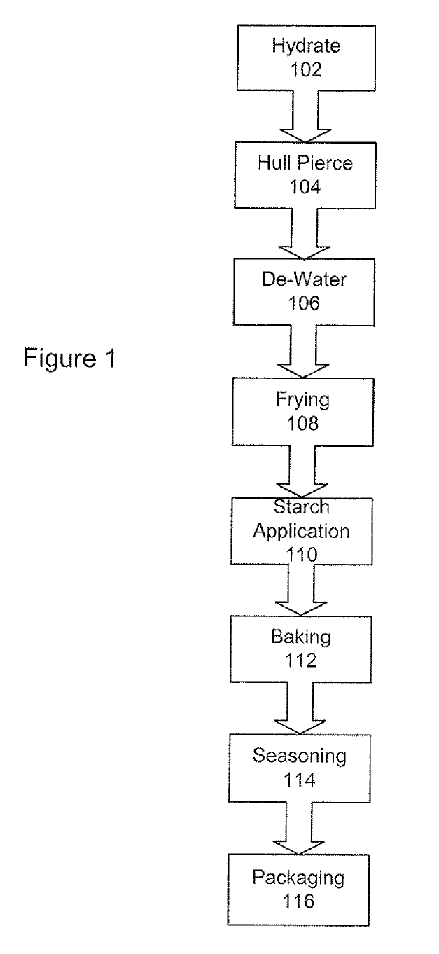

FIG. 1 illustrates one embodiment of the method for making the fried legume snack foods of Applicants' invention. The first step 102 involves hydrating a dried legume product. Typically this is done with water at ambient temperature to a moisture level of about 45% to about 60% by weight, and normally takes about 4 to about 12 hours. In an alternative embodiment, food coloring can be added to the water to enhance the color of the final product. For example, when peas are used as the legume in question, it is desirable to add a green food coloring or dye to the water to enhance the green color of the product after frying. In an alternative embodiment, fresh as opposed to dried legumes are used, in which case the hydrating step 102 can, in some instances, be omitted or significantly shortened.

In accordance with the embodiment illustrates in FIG. 1, the next step 104 in the process is to pierce the hull of the legume. It should be noted that this hull-piercing step 104 can alternatively occur prior to hydration 102. Further, the hull-piercing step can also occur after the de-watering step 106 shown in FIG. 1. The only requirement for this embodiment is that the hull-piercing step 104 occur prior to the frying step 108.

On an individual legume seed basis, the goal of the hull-piercing step 104 is to puncture or pierce the hull of the legume in at least one location on the legume seed. This can be accomplished by passing the legumes through a set of rollers wherein one or both rollers bristle with a plurality of sharp protrusions similar to needles. Alternatively, the legumes can be fed onto a belt that has a plurality of piercing devices such as needles. Another alternative for piercing the hulls is the use of a tumbling unit with pins located on the inside of the tumbler. In any event, the goal is to pierce substantially all of the legume seeds in at least one location on each seed in order to allow steam produced during the frying step 108 to escape through the hull of the legume without rupturing the hull.

It should be noted that this hull-piercing step 104 represents only one embodiment of Applicants' invention. In an alternative embodiment, sequential frying is used during the frying step 108, and will be described in more detail below. Further, certain legumes, such as chickpeas, resist hull rupturing sufficiently during frying without hull-piercing, provided the frying step 104 is closely controlled.

Either before or after the hull-piercing step 104, but after the hydrating step 102, the legumes are de-watered by a de-watering step 106. This de-watering step involves removing surface moisture from the legumes prior to the frying step 108. This can be accomplished, for example, by drying the surface of the legumes by blowing air onto the legumes.

After the de-watering step 106, the legumes are fried 108. In a preferred embodiment, the frying of the legumes takes place in a surface frying operation, as opposed to a submerged frying operation, in a fryer having an oil temperature of approximately 300° F. to 350° F. In order to avoid excessive oil pickup in the product, the legumes are fried to a specific oil content, such as between 12% and 20% oil-by-weight. Consequently, the frying step 108 is a par fry operation. Most preferably, the oil content at the end of the frying step 108 is between approximately 14% and 16% by weight, with a product moisture level of approximately 10% to 15% by weight.

After the product is fried 108, the legumes are then subjected to a baking step 110. This typically occurs in an impingement type oven, but other non-oil environment cooking, such as convection cooking, infrared cooking, and microwave cooking, can be used. The legumes are baked to a final moisture level, typically between 1% and 4% by weight, and more preferably between 2% and 3% by weight. After baking 110, the product can then be seasoned 114 by methods known in the art or, in an alternative embodiment, starch can be added 112 to the surface of the legumes. The seasoning step 114 can also be omitted in an alternative embodiment of Applicants' invention.

In one embodiment of the invention, a starch is applied 112 to the surface of the legume after the baking step 110. This is accomplished by spraying a syrup on the legume and then applying one or more layers of starch. The starch coated legume is then further dried in a second baking step (not shown) in order to remove excess moisture from the starch coating. Preferred starches in this regard are wheat starch and rice flour. The legume during the starch application step 112 can be partially coated with a starch layer, completely coated with a starch layer, or can be covered in several starch layers, with sequential spraying of syrup and starch addition. This addition of starch to the legume gives the end product multiples textures, with an initial light crispy texture followed by a heavier crunchy texture. The addition of starch during the starch application step 112 further reduces the total oil content of the end product in light of the bulk added to the product during this step. It should be understood that the starch application step 112 is an alternative step in Applicants' process and can be omitted depending on the end product desired.

After seasoning 114, the product is packaged 116 in, for example, a flexible bag produced by a vertical form, fill, and seal machine. The end product is shelf stable and can be stored and displayed at ambient temperatures.

One alternative embodiment of Applicants' invention substitutes the hull-piercing step 104 with sequential frying during the frying step 108. This involves frying the product for a period of time followed by removing the product from the hot oil to allow it to cool slightly followed again by immersing the product in hot oil for further frying. Depending on the legume product to be fried, the temperature of the oil, and the desired characteristics of the end product, this cycle can be repeated any number of times. For example, the product can be conveyed to a surface fryer where the product is fried in a monolayer for approximately thirty seconds and then removed for approximately thirty seconds for a resting stage prior to hot oil immersion in another monolayer frying arrangement. It is not necessary that the frying stages or the resting stages be of equal lengths, and the timing for each individual stage can be adjusted to optimize product characteristics and operational economics. This cycle of a frying stage followed by a resting stage in a preferred embodiment is repeated for between one and twenty times until (dependent mainly on the time for each cycle) the legume is fried to the desired oil content specified for the frying step 108. This sequential frying method allows the product time to cool slightly and release steam more slowly between each frying period, thus reducing the stress on the hulls and limiting the amount of rupturing taking place. The sequential frying described above can be facilitated on a continuous basis using oil flume technology or transfers between sequential fryers by a conveyor, or it can involve a series of batch frying steps conducted in a semi-continuous operation. It should also be understood that this sequential frying method can be combined with a hull-piercing step 104 to control rupturing of the legume hulls.

Applicants' method can be further illustrated with regard to a preferred embodiment using peas. First, a large seed variety of dried peas is obtained, for example the Colombian, Cruiser, or Marrowfat variety. These dried peas typically have a moisture level of between 11% and 12%. The peas are hydrated 102 in a water bath containing green food coloring to a moisture level of between 50% and 55% by weight. This normally takes between 8 and 10 hours to hydrate to such level at ambient conditions. Surface moisture is then removed from the peas during a de-watering step 106 and the peas are pierced during the hull-piercing step 104. The peas are then fried 108 in a monolayer in corn oil at approximately 320° F. to 330° F. for between about 4 to about 6 minutes. The peas are fried to a oil content of approximately 14% to 16% which relates to a moisture level of approximately 10% to 15%. The peas then proceed on a meshed conveyor to allow excess oil to drip off of the peas and are routed to an air-popper type oven, such as sold by C. Cretors and Company of Illinois. This type of oven blows air at a high velocity and at a temperature of approximately 300° F. through the layer of peas as they transit through the oven. This baking step 110 in the embodiment described takes approximately 5 minutes. The goal is to cook the peas to a finished moisture level of about 2% to about 3% by weight. The end product typically has a final oil content of between 12% and 13% by weight. In an alternative embodiment using peas, the starch application step 112 can also be used with the application of either a wheat starch or a rice flour. The peas are then baked again, seasoned 114 to the desired flavor and taste, and packaged 116.

Although Applicants' invention has been described specifically with regard to a process for frying peas, it should be understood that the concepts of Applicants' invention can be applied to any number of legumes, including, without limitation, chickpeas, lima bean, kidney beans, red beans, peas, pinto beans, black-eyed peas, black beans, soy beans, navy beans, cranberry beans, and mayocoba beans. Portions of Applicants' invention also have application to vegetables in general.

What is claimed is:

1. A method for making a fried legume snack, said method comprising the steps of:
a) hydrating whole legumes with hulls intact;
b) removing surface moisture from the legumes;
c) frying said legumes to an oil content of the legumes of 10% to 20% by weight; and
d) further cooking the partially fried legumes of step c) in a non-oil environment to a moisture level of about 1% to about 4% by weight.

2. The method of claim 1 wherein the hulls of the legumes are physically pierced prior to the frying step c).

3. The method of claim 2 wherein the hulls of the legumes are physically pierced after the hydrating of step a).

4. The method of claim 2 wherein the hulls of the legumes are physically pierced before the hydrating of step a).

5. The method of claim 1 wherein the frying step c) further comprises surface frying.

6. The method of claim 1 wherein the frying step c) further comprises at least two sequential frying stages with a resting period interposed between said at least two sequential frying stages.

7. The method of claim 1 wherein the legumes are fried at step c) to an oil content of about 14% to about 16% by weight.

8. The method of claim 1 wherein the legumes are further cooked at step d) to a moisture level of about 2% to about 3% by weight.

9. The method of claim 1 wherein the legume is selected from the group consisting of peas, lima beans, chickpeas, pinto beans, kidney beans, red beans, black-eyed peas, black beans, soy beans, navy beans, cranberry beans, and mayocoba beans.

10. The method of claim 9 wherein the legume consists of peas.

11. The method of claim 1 wherein the legume is hydrated at step a) to a moisture level of about 45% to about 60% by weight.

12. The method of claim 11 wherein the legume is hydrated to a moisture level of about 50% to about 55% by weight.

13. The method of claim 1 wherein a starch is added to the surface of the legume after step d).

14. The method of claim 13 wherein said starch comprises rice flour.

15. The method of claim 13 wherein said starch comprises wheat starch.

16. The fried legume snack made by the method of claim 1.

17. A fried legume snack comprising individual legume pieces having substantially intact hulls, a moisture content of about 1% to about 4% by weight, and an oil content of about 10% to about 15% by weight.

18. The fried legume snack of claim 17 wherein the legume is selected from the group consisting of peas, lima beans, chickpeas, pinto beans, kidney beans, red beans, black-eyed peas, black beans, soy beans, navy beans, cranberry beans, and mayocoba beans.

19. The fried legume snack of claim 18 wherein the legume consists of peas.

20. The fried legume snack of claim 17 further comprising added starch.

21. The fried legume snack of claim 20 wherein said starch comprises rice flour.

22. The fried legume snack of claim 20 wherein said starch comprises wheat starch.

23. The fried legume snack of claim 17 wherein said legume pieces have been physically pierced prior to cooking.
